(19) United States
(12) Patent Application Publication
(10) Pub. No.: US 2006/0078167 A1
(43) Pub. Date: Apr. 13, 2006

(54) Method and apparatus for on-line monitoring print quality

(76) Inventors: Ismo Heikkila, Helsinki (FI); Jarmo Seppanen, Helsinki (FI)

Correspondence Address: STEINBERG & RASKIN, P.C., 1140 AVENUE OF THE AMERICAS, 15th FLOOR, NEW YORK, NY, 10036-5803, US

(21) Appl. No.: 10/526,600

(22) PCT Filed: Sep. 3, 2003
(86) PCT No.: PCT/FI03/00642

§ 371 Date: Sep. 22, 2005

(30) Foreign Application Priority Data
Sep. 4, 2002 (FI) 20021576

(51) Int. Cl. G06K 9/00

(52) U.S. Cl. 382/112

(57) ABSTRACT

An apparatus and a method for measuring print quality in a printing press used in newspaper production, wherein the measuring apparatus measures several parallel reflection profiles extending in the longitudinal direction simultaneously across the entire width of a paper web and the measurement results of the measuring apparatus are used for the detection of waste and for the adjustment of inking in the printing press in real time.

The invention relates to monitoring print quality in a printing press during production. The purpose of the invention is to provide an apparatus for measuring print quality, the measuring results of which apparatus can be used for adjusting and monitoring the print quality of a printing press and to detect defects both in the printing press and in print quality.

The arrangements of prior art are based, for example, on imaging performed by means of a linear or matrix camera, on an analysis made based on an image and on the use of the analysis results for monitoring and controlling a printing press. The applicant's patent FI 95888, equivalent U.S. Pat. No. 5,774,635, relates to these arrangements. Other applicants' U.S. patents include, for example, U.S. Pat. No. 5,724,259 and U.S. Pat. No. 6,108,436. Devices of this kind for monitoring print quality are not yet available for newspaper printing presses, for other printing presses there are available finished systems. As compared with other printing presses, the newspaper printing presses generally have many wide paper webs and a fairly high speed, for example, 15 m/s. At the newspaper printing press, the edges of the product are not cut away, so possible test marks shall be inconspicuous. Moreover, since finished newspapers are sent immediately to the customer, late warnings of waste are of no use. Most prior art devices are based on different types of cameras and on image processing. In respect of these, accommodating the apparatus in connection with the printing press, the large amount of information to be processed with sufficient resolution, and achieving sufficient resolution cause problems. Traversing devices are not able to monitor quality simultaneously across the entire width of the web. The difficult elimination of scattered light is also a problem in implementations carried out with normal optics and cameras. A traversing measuring device may additionally allow a considerable amount of waste to pass through if an error occurs at times and only in part of a page.

An object of the invention is to achieve a system which measures the entire paper web being printed, which system can be used and put into use in a simple manner and the measurement results of which can be used for closed-loop control of the printing press and for waste warnings as well as for compilation of print run statistics. The apparatus is small in size and modular, in addition, some of the effect of scattered light and, for example, of the contamination of the optics by dirt has been eliminated as compared with the prior art.

The apparatus in accordance with the invention has good resolution in a longitudinal direction in order that the test marks be found reliably and a reliable measurement result be obtained to adjust colours based on a test mark. Transverse resolution is sufficient in respect of the width of inking zones for adjusting the colours and, in addition, sufficient for observing waste in real time so that every faulty page can be removed from production.

Advantageously, the system in accordance with the invention is modular. One exemplifying embodiment comprises three different modules. In the following, the invention is illustrated by means of figures.

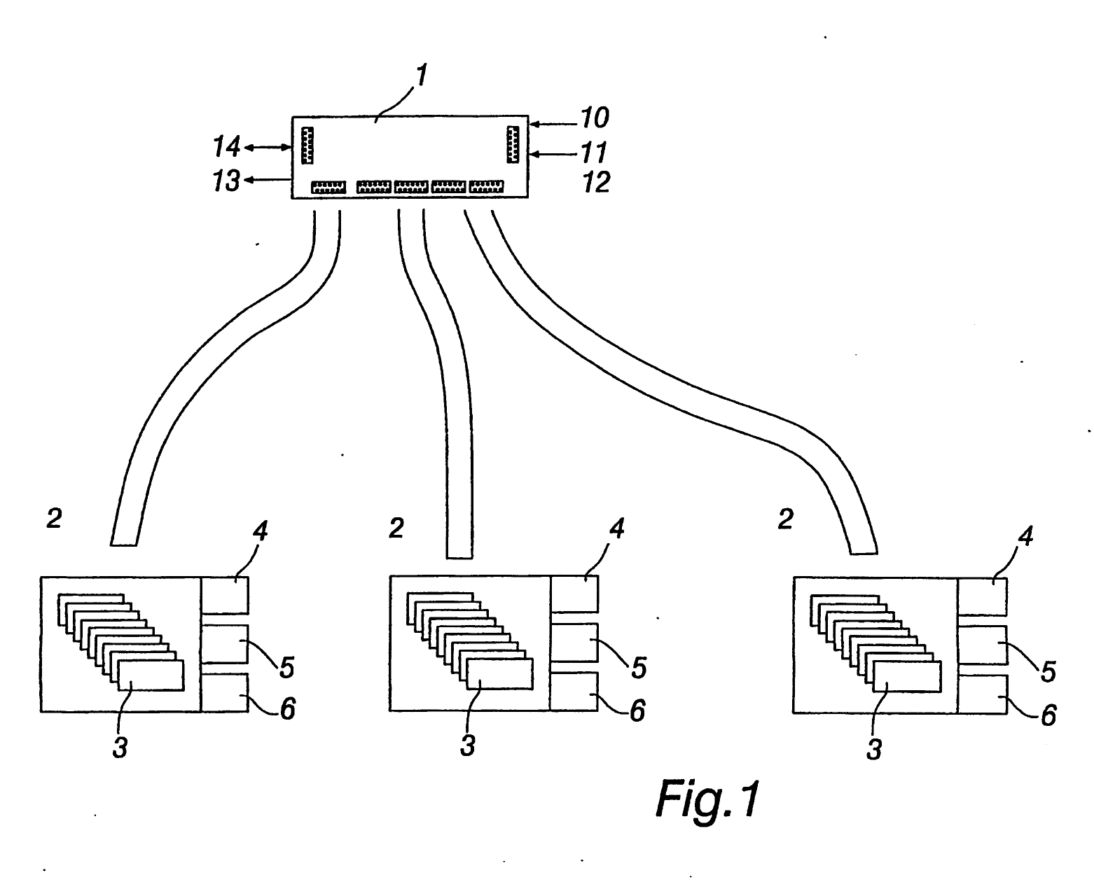

FIG. 1 shows the architecture of the measuring system as a block diagram.

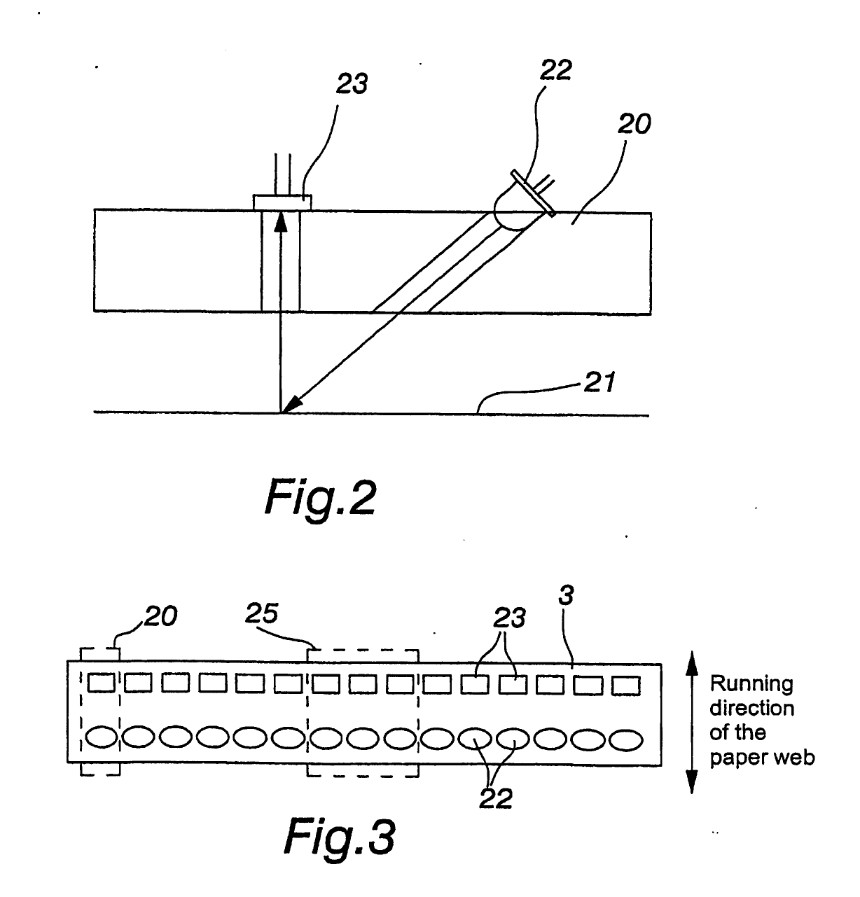

FIG. 2 shows a light source/detector pair of the measuring apparatus.

FIG. 3 shows the optics of the measuring apparatus as viewed from above.

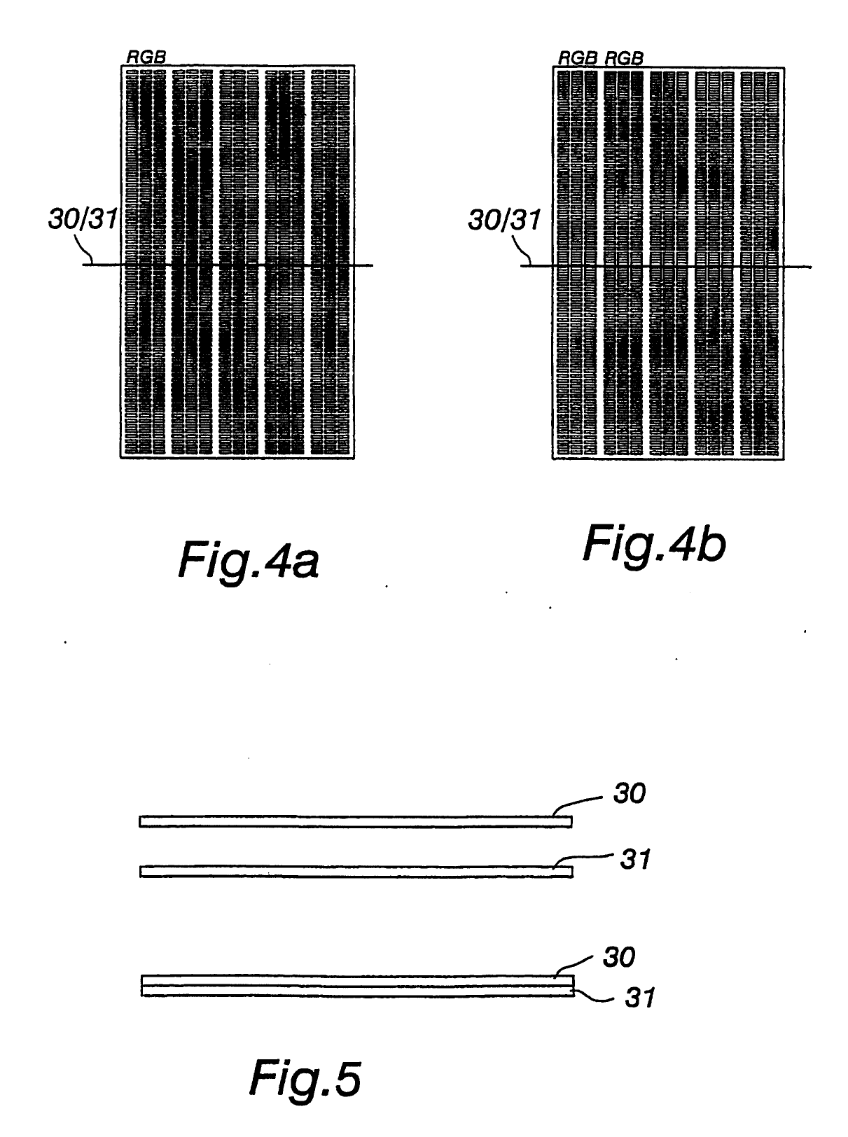

FIG. 4a shows the sampling principle of the measuring apparatus during search for a gray bar.

FIG. 4b shows the sampling of the measuring apparatus in respect of the gray bar and the rest of the page during normal operation.

FIG. 5 shows examples of test marks used in measurement.

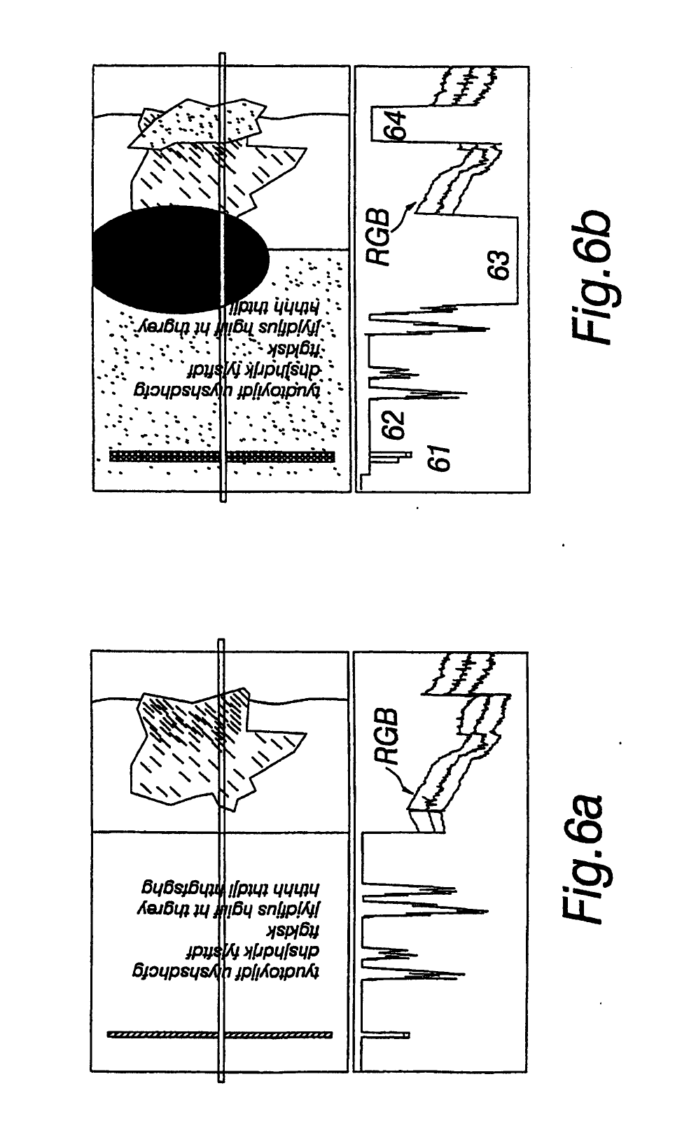

FIGS. 6a and 6b show measurement of a reflection profile and interpretation of measurement results in respect of one RGB detector.

FIG. 6a shows an accepted profile and the profile of FIG. 6b shows a few changes in profile caused by a typical error.

FIG. 1 clarifies the operation of the components of the measuring system. Its components are:

A distribution centre 1 is a centre of star-shaped cabling. The distribution centre 1 can be a centre that merely transmits signals to the control system of a printing press or in connection therewith there can be a PC that shows measurement results to the printer.

A measuring beam 2 is a mechanical beam that extends across the entire paper web. The beam also incorporates a connector card 4 with its connectors, a control computer 5, necessary current sources 6, a cooling means, and attachment parts for measuring modules 3.

The measuring module 3 is provided with light sources 22 (LED), detectors 23, and filters and optics needed in measurement. The module also has the electronics required for digitizing the measurement signal, a microprocessor, necessary memory circuits, and a data transmission bus for transferring measurement results to the control unit 5. A necessary number of measuring modules are attached to the measuring beam 2.

It is advantageous to distribute the data processing of the measuring system such that the measurement signals are analyzed in each module 3. In the normal operating situation, the modules 3 send merely analysis results to the control unit 5. This obviates the need for continuous transfer of a large amount of data so as to be processed centrally. The control unit 5 collects the results coming from the measuring modules 3 of one beam together and sends them further via the distribution centre 1 to a PC or to the automation system of the printing press. When needed, the system may have, for example, discrete control units for different paper webs or one unit takes care of the data processing of several measuring beams. The measuring of paper webs of different widths requires a different number of measuring modules in the measuring beam. By means of modularity it is possible to meet different needs at low costs.

FIG. 3 shows an RGB measuring head 25 of the measuring module 3. The measuring head comprises three light source/detector pairs 20 shown in FIG. 2. For the light source 22 is advantageously used an LED and for the detector 23, for example, a photodiode or a phototransistor. As compared with commonly used known CCD detectors, the photodiode provides considerably better dynamics, the phase locking described later further improves the measuring dynamics attained because of the compensation of scattered light and because of thermal compensation. Phase locking is possible specifically because of the structure in accordance with the invention, for example, phase locking cannot be arranged with a normal matrix or linear camera at sufficient operating speed. In addition, in the case of a camera, the problems caused by scattered light are great even though it would be possible to use phase locking. Because of the reflections of the optics and of the CCD cell, over 1% reflections result readily from other illuminated areas. The system in accordance with the invention avoids this problem. Moreover, it is possible to use filters and nonsimultaneous illumination by different measuring heads.

FIG. 2 is a side view from the direction of the edge of a paper web. FIG. 3 in turn shows a measuring module viewed from above or from below. The paper runs in the direction indicated by the arrow. The measuring module shown in FIG. 3 comprises five RGB measuring heads. One measuring module thus measures and monitors a 150 mm wide area on a printed page. The measuring modules are situated in succession on the measuring beam 2 extending across the paper web such that the entire paper web can be measured.

The print quality reflectivity measurement of the measuring head 25 is based on light source/detector pairs 20. A light source/detector pair is illustrated in FIG. 2. One pair measures one component colour and, thus, three light source/detector pairs 20 are required for making RGB measurement. The light source/detector pairs needed in making RGB measurement are called an RGB measuring head 25. One measuring head thus measures the reflectivity of red, green and blue light from the print. The output of the measuring head is constituted by three analog signals, which are proportional to the reflectivity of the print. The width of one measuring head is advantageously of the order of 30 mm at the most, and thus as wide as or narrower than the width of the inking zone of newspaper printing presses. The width of the measuring head determines the maximum resolution with respect to the transverse direction of the paper web, the narrower the measuring head, the higher the resolution that can be achieved in measurement. Because of ink adjustment, the width of the measuring head has to be equal to or narrower than that of the ink adjustment zone of the printing press. The same measuring head is also used for generating waste warnings.

For the sake of clarity, optics is not shown in the figures of the measuring head. A light beam can be collimated with lenses and in particular if all the light sources of the measuring module operate in the same phase, filters can be used in front of detectors to diminish the effect of scattered light from an adjacent light source. To keep any dirt carried with the flow of air away from the light travel path between the light source 22 and the detector 23, it is possible to use an air flow. This air flow is advantageously filtered air, the same air can be used for cooling. This too has not been shown in the figures.

The measuring module 3 makes use of phase locking in illumination and detection. Phase locking makes it possible to substantially reduce the effects of noise and also to eliminate the effect of ambient light on measurement results. The measuring technique also allows more than three detectors to be used in one module. In addition to the RGB detectors, the module may comprise, for example, a light source/detector pair that measures the reflection of red-green and blue-green light. As separate detectors it is also possible to use infrared and ultraviolet light for measurement. By this means, the assessment of the reflection spectrum is more accurate and, in addition, the spectrum can be measured within a wider wavelength range.

In phase locked measurement, the light source is switched on and off at a certain frequency. At receiving, the change in signal caused by this change is measured as locked to the phase of this switching. The method provides a considerable reduction in noise as compared with the CCD technique generally used. At the same time, the measuring errors caused by the dark current of the detector and ambient light are cancelled. Illumination is directed advantageously only at the area to be detected, so that the reflections outside the measurement area, coming from printed paper, cannot affect measurement. It is possible to illuminate adjacent areas at different times and measure a non-illuminated sample simultaneously with all detectors. By this means, the effect of adjacent light sources on measurement can be eliminated altogether. The minimization of the effect of light sources of different colours on the adjacent detector can be successfully accomplished simply by means of coloured filters. The illumination frequency that is used can be quite high when LEDs and fast photodiodes are used, whereby several samples are obtained for one area that is measured. The area to be measured is typically a test mark, white paper or an image detail. The samples can be detected, filtered and averaged either by an analog technique or by a digital technique. The averaging reduces measurement noise. Since the signals are processed locally, it is also easy to compensate for the effects of contamination on measurement dynamics. The goal of real-time operation is more easily achieved by local processing. The black level can be calibrated automatically due to the effect of phase-locked measurement, white can be calibrated as the highest value of the reflectivity measured from white paper from outside the area that is printed. In this connection, the handling of the error situations described later shall be taken into account. In fault situations it is not sensible to calibrate the system or perform any ink adjustments.

Note that the averaging of phase-locked measurement performed within one measurement point can also be advantageously carried out by the analog technique, for example, by means of an integrator, but the averaging of the measurement results of several pages is always performed digitally. The frequency of phase-locked measurement can also be equal to or higher than the measuring frequency of the reflection profile, advantageously a multiple thereof. The digital detection of the phase-locked signal can be accomplished simply by measuring, rapidly in succession, the amount of reflected light with the light source switched on and off. The signal itself is the difference between the measurement results. With the analog technique, detection can be performed prior to AD conversion. Thus, two samples are needed for one phase-locked measurement, one with the light source turned off and one with it turned on. One or more said phase-locked measurements can be averaged per one reflection intensity measurement. Phase-locked illumination can also be arranged such that the light is not turned off completely, but, instead, the change in the amount of the reflected light caused by a mere change in intensity is measured.

Calibration is performed continuously, otherwise, for example, when the paper roll after changing is darker than the preceding paper roll, the print would become lighter if the gray colour were adjusted to constant darkness only according to the test mark. The arrangement in accordance with the invention thus also measures the colour of paper from outside the printing area and is capable of adapting to the situation such that a change in paper tone does not cause an incorrect ink adjustment.

Advantageously, the measuring apparatus in accordance with the invention operates such that all real-time calculation is carried out in the measuring module 3. Transfer of large amounts of data is avoided by this system. The processor of the module reads the measuring signal coming from an AD converter, subjects it to digital filtering and calculates parameters from it, and averages and stores them. The averaged signal (page reflection profile) and the parameters are passed to a transfer buffer, from which they are passed to the control unit on request. This process operates all the time irrespectively of whether the control unit asks for data. Because of this principle of operation, the control unit always receives on its request the latest measurement results.

The measuring module also compares the longitudinal and transverse reflection profiles of the page measured and those of the reference page given and the parameters calculated from them. If the module finds that they differ from one another, it gives a binary waste alarm to the control unit.

Optomechanics: The circuit board of the measuring module 3 and the LEDs 22 and the photodiodes 23 used in illumination and detection are attached to an optomechanic base. The base has the optics needed in illumination and detection. The base is attached to a measuring beam. The base is schematically shown using the reference numeral 20. The optics comprises known collimator tubes, slits and possibly lenses and filters.

Measuring beam: One measuring beam 2 typically has 6-11 measuring modules 3 depending on the width of the printing press. The measuring beam is as wide as or slightly wider than the printing press and it thus measures one side of the web. At the lower edge of the measuring beam (between the beam and the paper web) there can be a transparent protective window attached to the beam. An air flow can also be used to reduce contamination by dirt. The reflection properties of the protective window determine, for their part, the effect of scattered light. Scattered light can be reduced using shaped or coated glass. By means of shaping, coatings and glass thickness it is possible to affect the behaviour of the light coming from LEDs. It is advantageous to reduce reflections, for example, by bending the plastic window such that the light meets it perpendicularly, for reducing scattered light it is also possible to use sections inhibiting movements of non-desired light or division of the window into several parts.

Control unit 5: The control unit 5 receives measurement data from the modules along one or, when needed, two parallel data transmission lines (not shown in the figures). All measurement data are transferred, for example, along a bus (RS-485). The control unit 5 asks (master) a module 3 (slave) for data of the measuring head 25 desired by it, and the module 3 sends the requested data to the control unit. The request for measurement data does not initiate measurements in the module 3, but the module returns on request the latest measurement results located in the transfer buffer.

A second line between the modules 3 and the control unit 5 is an optional binary waste alarm line. If some module finds that the print includes waste, it can send a binary waste alarm pulse along this line to the control unit 5. An alarm can also be transferred along the above-mentioned data transmission line together with other measurement data, in particular if the automation system asks for measurement results at each revolution of the cylinder. A separate waste alarm line can be used because of the real-time operation requirement of the waste alarm: it must be possible to remove every defective newspaper from production. When the control unit has received a waste alarm pulse and opened a waste gate, it asks along the bus for additional information about the quality of waste. Because of the distributed and parallel data processing, a waste alarm goes out in practice directly after a defective part of a page has passed beneath the measuring apparatus. When needed, it is possible to await until after the edge of the page has passed to identify possible contamination of a lens or an equivalent flaw. Defective newspapers or printed sheets are removed through the waste gate from the production line. In this way, every page can be measured separately and all defective newspapers can be removed. From the viewpoint of the newspaper printing press, this is very important because advertisers may refer to a failed edition and require a reduction of payments. It must also be possible to bring the newspapers for delivery within minutes from production. A defective batch cannot be examined any more afterwards. Because of the delay of a traversing measuring apparatus, defective newspapers may get into the mailing system. It is difficult to remove these from the mailing system. The arrangement in accordance with the invention allows the waste copies to be removed from production as selected one by one.

In the following, concepts relating to operation are described before a detailed description of the operation.

Synchronizing pulse: The measuring module needs from outside two binary synchronizing pulses. One pulse controls sampling (about 10,000 pulses per an impression cylinder revolution) and the other pulse controls the processing of measurement data (one pulse per a cylinder revolution).

Waste alarm: One output of the measuring module is a binary waste alarm. The alarm is processed in the control unit.

Control of the waste and sample gate: A possible output of the control unit is direct control of the waste and sample gate without intervention of the automation system or the operator.

Automation system: The apparatus in accordance with the invention is connected with the automation system through the distribution centre by means of Ethernet or some other bus.

Console: A separate PC called a console can also be connected to the distribution centre. The measurement results and the maintenance user interface can be displayed, in addition to the automation system, or only on the monitor of the console.

The system comprises databases for statistics and reporting and for a technical log.

In the following, the operation of the programs located in different parts of the system is described.

Before measurement is started, the components and memory areas of the apparatus are initialized. In that connection, parameters are loaded from the control unit to the measuring modules, memory areas of the module are allocated and initialized. This initialization can also be performed on external command.

After start-up, the measuring points intended for adjustment of inking are searched for either in pre-press data or by analyzing reflection profiles in the longitudinal direction of the page. The first object of measurements is to find the moment when the printing plates open. After that, the apparatus starts an automatic search for printing test marks. The module measures one or more measuring heads at a time and when a required number of measurements have been summed, the profiles are passed to the transfer buffer for transfer to the control unit. If a sufficiently high sampling speed is used, all measurements can always be made with full measurement resolution and it is possible to measure with all measuring heads in a non-interlaced mode at the same time. It is also possible to measure in an interlaced mode in a horizontal direction, i.e. alternately with different measuring heads.

Once the test marks have been found, the apparatus analyzes and learns the values of the test marks, for example, their locations and quality of print, as well as darkness. At this stage, either the operator's approval of the print quality or information inferred from the pre-press data about the desired darkness and shape of the test mark is needed.

At the beginning of the printing process, the module stores the measurement results and the parameters calculated from them in the memory bank of the module for use as reference for subsequent comparison. Comparison is made both for the identification of waste and for the adjustment of print quality. Profiles are processed in the modules locally and they can be transferred to the control unit or to be processed by the automation system. As a result of local processing, parameters and alarm data are obtained for use for adjustment and for removal of waste from production. Measured profiles can be transferred from the module to other parts of the system and vice versa, thus allowing values to be fine-tuned in addition to mere measurement.

When reference measurement profiles and the limits of error are known by the modules, ink adjustment and normal printing operation are started. During normal operation, the printing press is in working order and in the print quality there are no flaws caused by operational malfunctions of the machine or by the start-up phase. The adjustment of inking is possible only based on the test marks visible during normal operation.

When the module is at the grey bar, it measures the profile of the page with one measuring head or, in an alternative arrangement, with all measuring heads at the same time. If only some of the measuring heads are used for measurement at a time, several measurements are needed for ink adjustment in order that the length of the entire gray bar shall be measured. This is, however, totally acceptable because the adjustment of inking in a printing press is not very quick. When a required number of measurements have been averaged, the measurement data and analysis results are transferred to the transfer buffer in order to be passed to the control unit. Averaging reduces measurement noise and random variation at the cost of speed, this being advantageous for calming the adjustment down and for making it more accurate. The measurement results available at each moment have thus already been pre-averaged.

When the module is not at the gray bar, it measures the reflection profile of the page alternately with all measuring heads. In that connection, a longer sampling interval is used than in the measurements made at the gray bar. The measurements made from successive cylinder revolutions are not averaged, but the results and the parameters calculated from them are immediately stored in the transfer buffer for transfer to the control unit. The intention is to achieve a sufficient accuracy and speed for the identification of waste. Thus, it is possible to perform sampling less frequently as compared with the measurement of a narrow test strip.

The operation of the measuring apparatus and the analysis of the measurement results are based on the measurement of a reflection profile extending over the entire dimensions of the page. As appears from the description of operation, the reflection profile can be measured in different fashions depending on what is being measured. In the case of test marks, it is important to achieve high resolution, while real-time operation is more important in the identification of waste. By means of an interlaced arrangement a full-resolution image is achieved during several successive revolutions as a combination of several revolutions. In that connection, real-time operation is thus realized in observing those flaws which are larger than the resolution of partial images. In other words, flaws extending over an area of several millimeters are found immediately in practice. From measurement made very frequently, suitable parameters, such as averages and modes, minimum and maximum values from the envelope, can also be calculated directly before the other type of processing of measurement data.

Areas covered by inking zones can be inferred from the results of measurement in the transverse direction of the web by analyzing the measurement results either from one measured page or from the data on many different printed copies.

Reflection profile measurement is based on sampling that is controlled by a synchronizing pulse obtained from the printing press. The pulse can be taken from the control system or, alternatively, a separate pulse transducer can be installed in the printing press. Samples are taken over the entire length of a cylinder revolution, the result thus being a reflection profile whose length is equal to that of a cylinder revolution. The sampling interval may be constant over the entire length of a cylinder revolution. It may also vary depending on the object of measurement or on the intended use of measurement results.

FIG. 4. Sampling. The measuring apparatus measures the entire cylinder revolution. The sampling of the apparatus depends on how the measurement results are used. When the apparatus looks for a gray bar, it uses a constant and fairly long sampling interval, FIG. 4a. In normal measurements, the sampling interval is shorter in the case of density measurements than in the case of waste measurements, as shown in FIG. 4b. At the gray bar it is necessary to interlace measurement for a period of several revolutions if the speed of the apparatus is not sufficient otherwise. However, since the adjustment of inking is considerably slower than one cylinder revolution, this slowness is not detrimental to the control of the printing press. Less frequent sampling is in turn sufficient for the identification of waste.

The measured reflection profile can be used for measuring print darkness. The measurement can be made from a separate test mark, from an image area or by estimating ink consumption from measurement results. FIG. 5 shows one test mark, a gray bar extending across the entire page. The width of said test mark is 1.7 mm and during one impression cylinder revolution two test marks are printed, single-colour gray and three-colour gray. The marks can be placed apart from or adjacent to each other. The mark can be placed on the top or bottom margin of the page, but also, among other things, in the frame of an image being printed.

FIG. 4 shows two test mark pairs used in the measurement of print darkness. During one cylinder revolution, two marks are printed, single-colour gray and three-colour gray. The marks can be printed together or apart. In newspapers, the mark is generally in the top or bottom margin of the page or it can also be as separators of images or texts. From the viewpoint of adjustment of inking, it is essential that the marks continue across the entire width of the printed area at some point of the printed material. It is also possible to use, for example, three-colour gray only in connection with images or, for example, as separators of texts. Normally, the newspaper may have measuring marks as thin strips in the bottom and top margins of the page. Three-colour and reference gray lines may also be located on different pages.

The measured reflection profile is used not only for making print darkness measurements but also for identifying different flaws in printing. The identification of defects is based on a reference profile. The profile is measured from a page the print quality of which has been approved. Alternatively, the profile can be analyzed from pre-press data. The profile is stored in the memory of the measuring module at the beginning of the printing process. All subsequent profile measurements are compared with the reference profile. Deviation of the measured profile from the reference profile indicates a flaw in print quality.

Deviation of the measured profile from the reference profile may also be caused by a sudden contamination of a lens. The measuring module assesses the cause of the flaw by examining the measured reflection profile. If the contrast of the reflection profile diminishes abruptly over the entire length of the profile (also outside printing surfaces), the flaw is likely to be caused by the contamination of the lens. In this case, the module sends a measurement error signal to the control unit. Otherwise the module sends a waste warning.

FIG. 6 shows examples of the identification of flaws from a measured reflection profile. The profiles of different colours corresponding to a page are shown underneath the page. FIG. 6a shows an accepted profile of a reference page. The curves under the images correspond to reflection profiles of different colours R G B. Various flaws can be identified from FIG. 6b: a register difference 61 in the printing of the test mark, wherefore the edges of the colour components in the gray bar ascend and descend at different points. Darkening 62 of white paper, wherefore the white colour does not receive full intensity, an ink blotch 63 which drops reflectivity to a level considerably lower than normal, the curves being thus down and the area without printing ink 64, which causes a white area, i.e. too high reflectivity. The defects can be observed readily from the reflection profiles. In a measurement situation, the latest reflection profile measured is compared with the reference profile measured and stored at the beginning of the printing process.

1. An apparatus for measuring, in connection with a printing press, print quality of the printing press used in the production of newspapers, which apparatus is provided with light sources illuminating a moving paper web and with photo detectors measuring the light reflected from the surface of the paper web and sent by the light sources, wherein the apparatus is arranged to measure, continuously during the running of the printing press and simultaneously substantially across the entire width of the paper web, several parallel reflection profiles that extend in the longitudinal direction substantially over the entire page, and use the measurement results of the measuring apparatus in real time for the detection of waste and for the adjustment of inking in the printing press.

2. An apparatus as claimed in claim 1 for measuring print quality, wherein the apparatus is arranged to identify the normal operation of the printing press from reflection profiles measured substantially over the entire area of a page, and measure parameters needed in closed-loop control of the printing press only during said normal operation of the printing press, and at other times analyze from the measured reflection profiles only waste parameters, which are used to bring the printing press to normal operation.

3. An apparatus as claimed in claim 1 for measuring print quality, wherein the apparatus infers the locations of test marks used for closed-loop control from the measurement results of the reflection profiles substantially covering the entire page.

4. An apparatus as claimed in claim 1 for measuring print quality, wherein the light source used for measuring the reflection profile illuminates substantially only the area seen by each detector that measures reflection.

5. An apparatus as claimed in claim 4, wherein the light source and the photo detector operate as phase-locked.

6. An apparatus as claimed in claim 1 for measuring print quality, wherein the apparatus infers the validity of the measurement results for closed-loop control from the measurement results of the reflection profiles substantially covering the entire page.

7. An apparatus as claimed in claim 1 for measuring print quality, wherein sampling is more frequent at the test marks than elsewhere.

8. An apparatus as claimed in claim 1 for measuring print quality, wherein the light sources used for measuring the reflection profile are LEDs operating at different wavelengths.

9. A method for measuring and monitoring print quality of a printing press used in the production of newspapers based on reflection profile measurements, wherein a moving paper web is illuminated by means of light sources and the light reflected from the surface of the paper web and sent by the light sources is measured by means of photo detectors, wherein the method determines reference profiles at the beginning of the printing process and measures reflection profiles during production substantially from the entire area of a page, in the longitudinal direction substantially over the entire page and substantially across the entire width of the paper web, the measuring and monitoring of the print quality during production being based on comparing the reflection profiles measured and the reference profiles and on calculating parameters, on the basis of which it is inferred as to when the operation of the printing press is normal, and during said normal operation the darkness of the print is measured from test marks or from another part representing a given darkness of the print, and inking in the printing press is adjusted based on the result of measurement.

10. A method as claimed in claim 9 for measuring and monitoring print quality based on reflection profiles, wherein the measurement of the reflection profiles is made as a sampling measurement such that sampling is more frequent at test marks than in the area of the rest of the page.

11. A method as claimed in claim 9 for measuring and monitoring print quality based on reflection profiles, wherein the reflection profiles are processed in parallel in several modules.

12. A method as claimed in in claim 9 for measuring and monitoring print quality, wherein an accepted page indicated by the printer or inferred by the system or calculated from a pre-press data file is used as reference.

13. A method as claimed in in claim 9 for measuring and monitoring print quality, wherein the cause of a flaw in print quality is inferred based on the measurement data of the reflection profile of a page, i.e. whether a flaw in print quality is caused by water marking, toning, ink blotches or by areas having too little printing ink.

14. A method as claimed in in claim 9 for measuring and monitoring print quality, wherein the results of continuous profile measurement are used for assessing the condition of the printing press.

15. A method as claimed in in claim 9 for measuring and monitoring print quality, wherein from the results of continuous profile measurement it is inferred at the beginning of printing as to when printing plates open and the measuring apparatus starts only after that an automatic search for test marks and possibly also informs the control and automation system of the printing press about the opening of the printing plates, for example, a device measuring a register difference, so that these can also start measurements and adjustment.

16. A method as claimed in in claim 9 for measuring and monitoring print quality, wherein the results of continuous profile measurement are also used for analyzing failure of the printing press, for example, by means of recurrent darkness variations, among other things, bearing defects of the printing press, wear of a cylinder blanket or depressions in cylinder blankets, uneven wear of printing plates, worn rollers or worn bearer rings are advantageously identified.

17. A method as claimed in in claim 9 for measuring and monitoring print quality, wherein the results of continuous profile measurement are used for analyzing the printing of the test mark and if there are flaws in the printing of the test mark, such as a significant register difference, toning or ink blotches, the colour measurement system warns the printer and/or the automation system of a measurement error and stops closed-loop control of ink feed.

18. A method as claimed in in claim 9 for measuring and monitoring print quality, wherein the results of continuous profile measurement are used for assessing failure of the measuring apparatus (self-testing) by also measuring non-printing areas, so that a permanently reduced contrast between white and black indicates contamination of the measuring apparatus.

19. A method as claimed in in claim 9 for measuring and monitoring print quality, wherein the results of continuous profile measurement can be used in the calibration of the measuring apparatus such that the apparatus measures the reflection profile of the entire page, searches for and analyzes test areas and calibrates itself automatically.

20. A method as claimed in in claim 9 for measuring and monitoring print quality, wherein the results of continuous profile measurement are used for collecting production data, such as for measuring ink consumption and for analyzing production mode.
